(19) United States
(12) Patent Application Publication
(10) Pub. No.: US 2019/0042645 A1
(43) Pub. Date: Feb. 7, 2019

(54) AUDIO SUMMARY

(71) Applicant: SPEECHPAD, INC., Mountain View, CA (US)

(72) Inventors: Konstantin OTHMER, Los Altos Hills, CA (US); Michael RUF, Parkland, FL (US)

(21) Appl. No.: 16/054,844

(22) Filed: Aug. 3, 2018

Related U.S. Application Data
(60) Provisional application No. 62/541,471, filed on Aug. 4, 2017.

(51) Int. Cl. G06F 17/30; G10L 15/26; G10L 15/187; H04M 1/656

(52) U.S. Cl. CPC G06F 17/30719; G10L 15/265; H04M 1/656; G06F 17/30749; G10L 15/187

(57) ABSTRACT

A method of generating an audio summary may include recording multiple calls between a user device and one or more remote devices, and generating a textual representation of a conversation for each of the recorded calls. The method may also include providing a call history user interface on the user device from which each textual representation may be accessed.

### BACKGROUND

Telephones may provide call histories. Information related to who was called, who called, when a call took place, and a duration of the call may be provided. Often, users want to know more about calls that they had.

The following description provides examples of features of methods and systems. Useful embodiments may include fewer than all of the features described below. The subject matter claimed herein is not limited to embodiments that solve any disadvantages or that operate only in environments such as those described above. Rather, this background is only provided to illustrate one example technology area where some embodiments described herein may be practiced.

### SUMMARY

Using a combination of automated speech recognition and text summary that may optionally be linked to the audio of a call, a much higher value record of previous calls may be created. These records may be accessed directly from the call history and may be saved on the Internet. Audio summaries may be made for all calls, may be made for specific calls, and may be enabled or disabled before, during, or after a call.

The audio summaries of previous calls may be integrated with existing phones. The audio summaries of previous calls may be integrated with a phone call history display. An audio summary for a particular call may identify and pick out specific things that may be recognized, including, for example, addresses or phone numbers. The audio summary may include a summary of topics that are discussed during the call. The summary of topics may be presented as a word cloud of topics. The audio summary may include action items. The action items may be displayed as icons on the display of the phone. The audio summary may include an option for a user to manually add notes regarding the call. The call history may include a search box which a user may use to find calls where a search term appears in the notes of the audio summary.

The audio summaries may also be integrated with call initiation. On initiation, the items from previous calls may be brought up or displayed on a screen of the phone. The audio summaries may also be integrated with a contact list. Using the contact list, specific contacts may be included or excluded from audio summaries. During a call, a user may have the ability to turn the system on and off. The audio summaries may also be integrated with a calendar on the phone. Follow-up meetings may be identified from call notes and may be added to the calendar on the phone. The audio summaries may also be integrated with To-Do tools on the phone. The after call To-Do list may include scheduling meetings, actions items, or other items based on the call.

The audio summaries may also be integrated with a carrier. Recorded calls may be recorded directly in the carrier datacenter using the wiretap interface and may be controlled through touch tones or voice (“recording on,” “recording off”).

The audio summaries may include a variety of functions. The audio summaries may summarize a call automatically with a subject, a number of participants, and topics discussed. The audio summaries may include the ability to click on topics and listen to underlying audio. The text or the full file of the audio summaries may be shared. The audio summaries may be searchable via text or voice. Searching the audio summaries may produce a list of previous calls or people on the calls that contain the searched item or items. The audio summaries may be phonetically searchable. Voice search may become more accurate when the speaker is looking for something that the speaker said during the call. A party with the app may share recordings of calls with parties that do not have the app. Audio summaries may include the ability to speak specific tags or voice commands to explicitly mark parts of the call such as, for example, To-Do, Summary, Decision, Follow-up. During calls, the app may be used to insert bookmarks which may then be utilized when reviewing the corresponding audio summaries.

Audio summaries may include privacy and legal protections. Beeps or an announcement may be made during a recording based on the jurisdiction of each party to the call. When the recording system is turned on or off, one or more parties may be notified. When an originating party is placing a call, the originating party may set a default recording option. The originating party may also check a box to turn recording on or off. With the recording option turned on, when a called party answers the call, the called party may hear a notification that the call will be recorded. The called party may have the option to opt in or opt out of the call recording. The called party may also hear a notification that it may receive a summary of the call. The called party may receive a summary to the number at which it was called, for example via SMS text link. If the called party is using a phone not capable of SMS, the called party may enter a number to receive the link or may say an email address to receive the link.

Calls may be recorded with each party on its own channel. For example, in a two-party call, a stereo recording may be used with one party on the left and one on the right. In a multiparty call, multiple audio files may be used with one user per file or multiple users per file using multiple audio channels per audio file.

Audio summaries may also provide user directed selective deletion. Optionally, with privacy settings on, after a call, a user may edit portions of the call recording where the user was speaking. Audio summaries may include automated identification of sensitive areas and either block the sensitive areas or allow a user to block the sensitive areas. For example, in some embodiments, confidential sections of an audio recording may be identified by key words. For example, in response to identifying words such as “off the record,” “between you and me,” “don't tell anyone,” “confidentially,” or other phrases, sections of an audio recording may be identified as confidential. In these and other embodiments, portions of audio summaries that are identified as confidential may be played back or viewed by the speaker who indicated confidentiality. Other participants to the audio recording may see “<PRIVATE>” or a similar tag where the speaker indicating confidentiality spoke. In these and other embodiments, the speaker indicating confidentiality may delete the audio associated with the portion marked confidential or may share the confidential portion. In some embodiments, the speaker may mark specific portions of a confidential section as permissible to share. A called party may be made aware of the audio summaries and the call recording and may have control features in addition to the calling party. If both parties to a call have the app, recording permissions may be implicitly granted to both parties or notification may be shown to both parties when one party initiates recording of the call. Both parties may have access to the recording of the call. After the call, a link to the audio summary may be sent via SMS or email to both parties.

Audio summaries may also be generated from audio recorded using a microphone. For example, a meeting may be recorded using a microphone, such as, for example, a microphone included on a telephone. A meeting summary may be generated from the audio recorded similar to an audio summary generated during a call.

Multiple views of audio summaries may be generated in parallel. Each of the multiple views may be accessed by a user. There may be multiple layers in a summary. For example, the layers may include a summary layer, a detailed layer, and an audio layer. Users may configure the summary to include different views.

Audio summaries for audio or video calls between devices may be generated using a recording of the call along with speech recognition of the recorded call. Text of the recorded call may be analyzed to determine topics, subjects, addresses, times, dates, locations, follow-up items, names, or participants in the call. The audio summaries may be linked with other applications on the telephone, including calendar applications and to-do tools to generate calendar appointments and action items. An audio summary may provide a link between the text of the call and the recorded audio of the call. A user may be able to manually add notes to an audio summary in addition to the automatically generated text for the audio summary. Audio summaries, notes, and the text of the call may be searchable by text or by voice by a user. The audio summaries may be shared with others. Audio summaries may additionally provide privacy and legal protections to participants in calls, which may be based on the jurisdiction where each participant in the call is located.

### BRIEF DESCRIPTION OF THE FIGURES

Features, aspects, and advantages of the present disclosure can be better understood according to the following Detailed Description and the accompanying drawings.

FIG. 1 illustrates a block diagram of an environment 100 for an audio summary.

FIG. 2a illustrates an example embodiment of a call history.

FIG. 2b illustrates an example embodiment of a search of a call history.

FIG. 2c illustrates an example embodiment of a call information.

FIG. 2d shows an additional example embodiment of a call information.

FIG. 3 is a flowchart of an example process for an audio summary.

FIG. 4 shows an illustrative computational system for performing functionality to facilitate implementation of embodiments described herein.

### DETAILED DESCRIPTION

Systems and methods are disclosed for generating an audio summary.

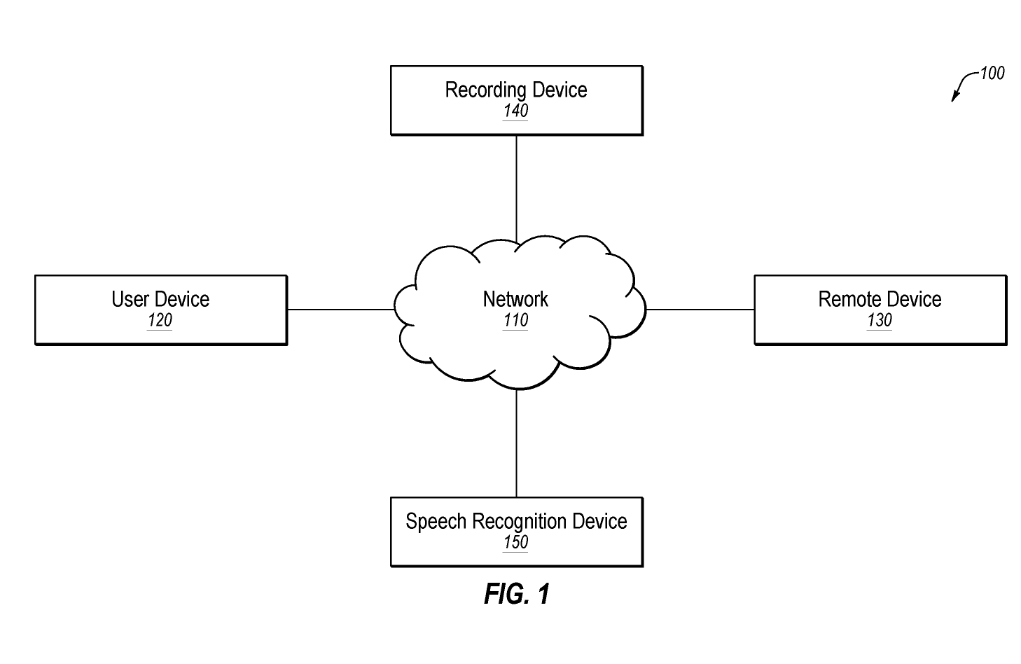

FIG. 1 illustrates a block diagram of an environment 100 that may be used in various embodiments. The environment 100 may include a network 110, a user device 120, a remote device 130, a recording device 140, and a speech recognition device 150. The user device 120 may include any type of processing device such as, for example, a laptop computer, a tablet computer, a cellular telephone, a smartphone, a smart device, a tablet, a desktop computer, etc. The remote device 130 may include any type of processing device such as, for example, a laptop computer, a tablet computer, a cellular telephone, a smartphone, a smart device, a tablet, a desktop computer, etc. While only one device is illustrated, any number of remote devices may be used (such as for multiple distinct calls, multi-party calls, etc.). The user device 120 and the remote device 130 may be positioned anywhere such as, for example, within the same geographic location, in separate geographic locations, in different legal jurisdictions or countries, etc. For example, in some embodiments, the user device 120 and the remote device 130 may be operated in different states or countries and may be subject to different legal requirements regarding recording audio and/or video conversations.

The user device 120 and the remote device 130 may be coupled with the network 110. The network 110 may, for example, include the Internet, a telephonic network, a wireless telephone network, a cellular network (e.g., a 3G network, an LTE Network), a data network, etc. In some embodiments, the network may include multiple networks, connections, servers, switches, routers, connections, etc. that may enable the transfer of data. In some embodiments, the network may include one or more LAN, WAN, WLAN, MAN, SAN, PAN, EPN, and/or VPN. The user device 120 and the remote device 130 may be configured to participate in calls, including audio calls and video calls, with each other through the network 110. For example, in some embodiments, the user device 120 may place a call to or receive a call from the remote device 130 through a cellular telephone network. Alternatively or additionally, in some embodiments, the user device 120 may place a call to or a receive a call from the remote device 130 through a Voice over Internet Protocol (VoIP) service, a video VoIP service, or a public switched telephone network (PSTN) service.

The environment 100 may also include a recording device 140. The recording device 140 may include any type of processing device such as, for example, a laptop computer, a tablet computer, a cellular telephone, a smartphone, a smart device, a tablet, a desktop computer, etc. In some embodiments, the recording device 140 may include a server in a network. In some embodiments, the recording device 140 may be configured to record audio conversations or video conversations that take place between the user device 120 and the remote device 130. For example, the audio of a cellular telephone conversation between the user device 120 and the remote device 130 may be stored as data by the recording device 140. The recording device 140 may be configured to generate call recordings. Alternatively or additionally, in some embodiments, audio and/or video from a video VoIP session may be stored as data by the recording device 140. Alternatively or additionally, in some embodiments, the recording device 140 may be configured to generate a recording from a speaker, e.g., from a single electronic device. For example, in these and other embodiments, generation of an audio recording may not include a call between the user device 120 and the remote device 130. In some embodiments, the recording device 140 may be part of the user device 120. For example, the user device 120 may include storage media that stores the call as it is recorded.

In some embodiments, the recording device 140 may be configured to record a call between the user device 120 and the remote device 130 in response to a user of the user device 120 pressing a button or selecting an option on a screen of the user device 120 during the call. Alternatively or additionally, the user of the user device 120 may select to record calls with particular contacts of the user, may select to not record calls with particular contacts of the user, may select to record every call, or may select other recording options. In some embodiments, the user may designate a whitelist of people, contacts, or other remote addresses for which all calls are to be recorded. Additionally or alternatively, the user may designate a blacklist of people, contacts, or other remote addresses for which no calls are to be recorded. In some embodiments, a person may be so-designated (e.g., either on a whitelist or blacklist) on a contact profile for the person. In some embodiments, the user may select to record a part of a call. For example, a user may begin recording the call at one point in time and cease recording the call at a second point in time. In some embodiments, recordings of calls may be accessible from the user device 120 or from a web browser on another device. The recording of a call may be associated with call initiation from the user device 120.

In some embodiments, the recording device 140 may be configured to provide an audio notification that a recording of the call is being made. For example, in some embodiments, the recording device 140 may include a beep or an announcement regarding the recording. In these and other embodiments, the selection of a beep or an announcement may be based on a location of the remote device 130. For example, different jurisdictions may be subject to different laws regarding recording calls. In some embodiments, a user of the user device 120 and/or a user of the remote device 130 may direct the recording device 140 to selectively delete portions of the recording. In some embodiments, the recording device 140 may be configured to identify sensitive areas and block recording of those areas or allow the user of the user device 120 or the user of the remote device 130 to block those areas. For example, in some embodiments, the recording device 140 may be configured to identify speech concerning the personal medical history of an individual. In response to identifying the speech, the recording device may be configured to not record the portion of the call including the personal medical history or may be configured to allow a party to the call to select to not record the portion.

In some embodiments, a user of the user device 120 and a user of the remote device 130 may each have control features over the recording of the call. For example, in some embodiments, each of the users may have the option to prevent recording of the call or to prevent recording of some parts of the call.

In some embodiments, the recording device 140 may be associated with software on the user device 120, on the remote device 130, or on both the user device 120 and on the remote device 130. For example, in some embodiments, the recording device 140 may be associated with an application or app on the user device 120 or the remote device 130. In these and other embodiments, if both the user device 120 and the remote device 130 have the app, recording permissions may be implicitly granted to both parties. Alternatively or additionally, a notification may be shown to both parties in response to either party initiating a recording of the call. In some embodiments, both the user device 120 and the remote device 130 may have access to a recording of the call generated by the recording device 140.

In some embodiments, the recording device 140 may be associated with a wireless telephone service provider or carrier. In these and other embodiments, the recordings generated by the recording device 140 may be stored in a datacenter of the carrier using a wiretap interface. In these and other embodiments, the recording device 140 may be controlled through touch tones on the user device 120 or the remote device 130 or by voice commands such as, for example, “recording on” or “recording off.”

In some embodiments, telephone service providers may provide an interface via which law enforcement or other government agencies may be able to “tap” into communications, for example, to comply with the Communications Assistance for Law Enforcement Act (CALEA). In some circumstances, embodiments of the present disclosure may interact with the same interface via which law enforcement is able to “tap” into calls or other communications, and use the same interface to generate textual transcriptions of the calls, summaries of the calls, reminders from the calls, etc.

The environment 100 may also include a speech recognition device 150. The speech recognition device 150 may include any type of processing device such as, for example, a laptop computer, a tablet computer, a cellular telephone, a smartphone, a smart device, a tablet, a desktop computer, etc. In some embodiments, the speech recognition device 150 may include a server in a network. In some embodiments, the speech recognition device 150 may be configured to recognize speech in an audio conversation. For example, in some embodiments, the speech recognition device 150 may detect speech in audio data or video data, such as audio conversations or video conversations recorded by the recording device 140. In these and other embodiments, the speech recognition device 150 may recognize the particular words that are spoken in an audio conversation or a phone call. In these and other embodiments, the speech recognition device 150 may obtain the audio conversations or video conversations from the recording device 140 via the network 110. In some embodiments, the speech recognition device 150 may detect speech in audio data or video data obtained during a call between the user device 120 and the remote device 130 without recording the call. In some embodiments, the speech recognition device 150 may employee speech recognition software, such as that developed and used by DRAGON SYSTEMS, NUANCE, etc.

In some embodiments, the speech recognition device 150 may be configured to generate a text summary of a call based on the detected speech in the call. For example, in some embodiments, the speech recognition device 150 may be configured to differentiate between different participants in a call. For example, although described with respect to a single user device 120 and a single remote device 130, there may be any number of user devices 120 and remote devices 130. In these and other embodiments, the speech recognition device 150 may be configured to identify which elements of the call were spoken by each of the participants in the call. The text summary of the call may include one or more subjects of the call, including topics discussed, addresses or locations mentioned, dates or times mentioned, the number and identity of participants in the call, tasks assigned to participants in the call or other individuals, topics mentioned during the call, names of people mentioned, or other elements of the call.

In some embodiments, the speech recognition device 150 may be configured to identify specific parts of the call, such as action items, to do lists, summaries, decisions, points for follow up, and confidential sections. In some embodiments, a participant in the conversation may say words associated with different parts of the call. For example, in these and other embodiments, a participant may use the words “in summary” or analogous words. In response to detecting the words, the speech recognition device 150 may identify these words and following words as a “Summary” of the call. Alternatively or additionally, in some embodiments, a user of the user device may use voice commands or may speak specific tags to explicitly mark parts of the call. For example, in some embodiments, a user may identify a decision made during the call while listening to a recording of the call by vocalizing a voice command. For example, in these and other embodiments, confidential sections of an audio recording may be identified by key words such as “off the record,” “between you and me,” “don't tell anyone,” or “confidentially.” In response to identifying words or phrases indicating confidential sections, the speech recognition device 150 may identify sections as confidential and may not display a textual summary of the conversations to other participants in the audio recording. In these and other embodiments, portions of audio summaries that are identified as confidential may be played back or viewed by the speaker who indicated confidentiality. Other participants to the audio recording may see “<PRIVATE>” or a similar tag where the speaker indicating confidentiality spoke. In these and other embodiments, the speaker indicating confidentiality may delete the audio associated with the portion marked confidential or may share the confidential portion. In some embodiments, the speaker may mark specific portions of a confidential section as permissible to share.

In some embodiments, elements of the text summary may be linked with audio from the call. For example, in some embodiments, a user may be able to “click,” “tap,” “select,” or otherwise identify (hereinafter simply “click” or “select”) a topic in the text summary and listen to the audio from the call associated with the topic. Alternatively or additionally, in some embodiments, a user may be able to “click” or “select” a topic in the text summary and read a transcription of the audio from the call associated with the topic.

In some embodiments, the speech recognition device 150 may be configured to provide an option to search through calls by inputting text into the user device 120. Speech recognition device may search through calls by participants, by topics, by subjects, by names, or by any other element of the calls. In some embodiments, the speech recognition device 150 may be configured to display a list of previous calls or of people involved in the calls that contain the search term. Alternatively or additionally, in some embodiments, the speech recognition device 150 may be configured to provide an option to search through calls by inputting an audio signal into the user device 120. For example, a user of the device may speak the search term instead of or in addition to entering the search term as text. Audio summaries may be phonetically searchable. In these and other embodiments, the speech recognition device 150 may be configured to be more accurate in response to a user speaking search terms that the user used during the call. For example, the speech recognition device 150 may have improved accuracy in finding words spoken in a call when the voice used to input the search words is the same voice that said the search words during the call.

In some embodiments, the text summary generated by the speech recognition device 150 may be integrated with software on the user device 120. For example, in these and other embodiments, dates, times, and locations mentioned in the text summary may be used to generate calendar appointments or events on the user device 120. In some embodiments, the tasks and action items identified in the text summary may be used to generate items in a To-Do list on the user device 120. In some embodiments, the text summary from the speech recognition device 150 may be integrated with a call history provided by the user device 120. In these and other embodiments, a user of the user device 120 may be able to search through the call history using topics, names, locations, dates, or other elements of the text summary. In some embodiments, the user may search for calls related to a search term appearing in the notes associated with the call history.

In some embodiments, after the generation of an audio summary, a text or an email may be sent to participants in the audio recording who do not have accounts for an application associated with the audio summaries. In some embodiments, the text or email may include the audio summary. Alternatively or additionally, in some embodiments, the text or email may include a link to the audio summary. If a user has an account with the application, a notification may be provided to the user via the application running on the user device 120 concerning the availability of the audio summary.

Modifications, additions, or omissions may be made to the environment 100 without departing from the scope of the present disclosure. For example, in some embodiments, the user device 120, the recording device 140, and the speech recognition device 150 may be a single device. Alternatively or additionally, in some embodiments, the user device 120 and the speech recognition device 150 may be a single device and the recording device 140 may be a separate device. In some embodiments, the user device 120 may include the recording device 140 and the remote device 130 may also include a recording device. In these and other embodiments, both the user device 120 and the remote device 130 may record the call. Alternatively or additionally, in some embodiments the remote device 130 may record the call. In some embodiments, the environment 100 may not include the remote device 130. For example, in these and other embodiments, a meeting may be recorded by the recording device 140.

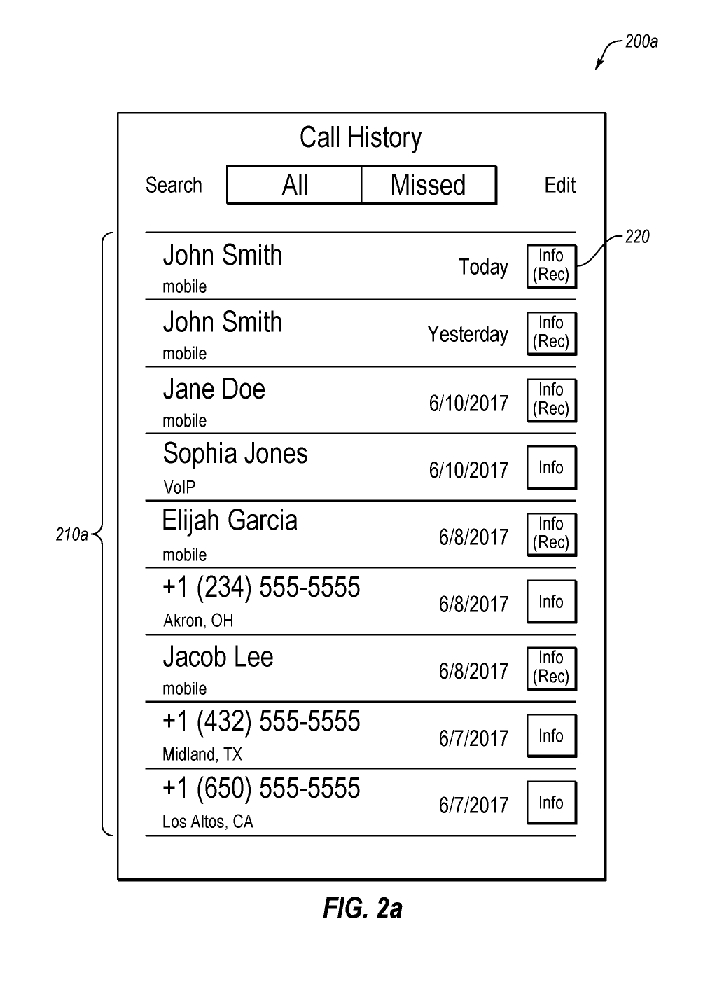

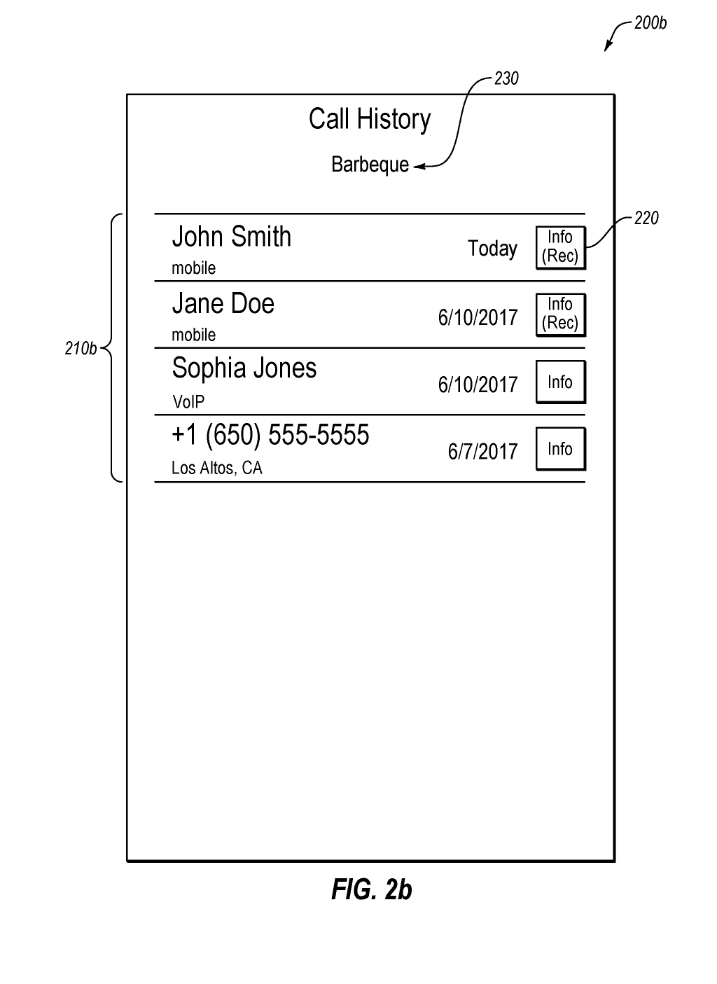

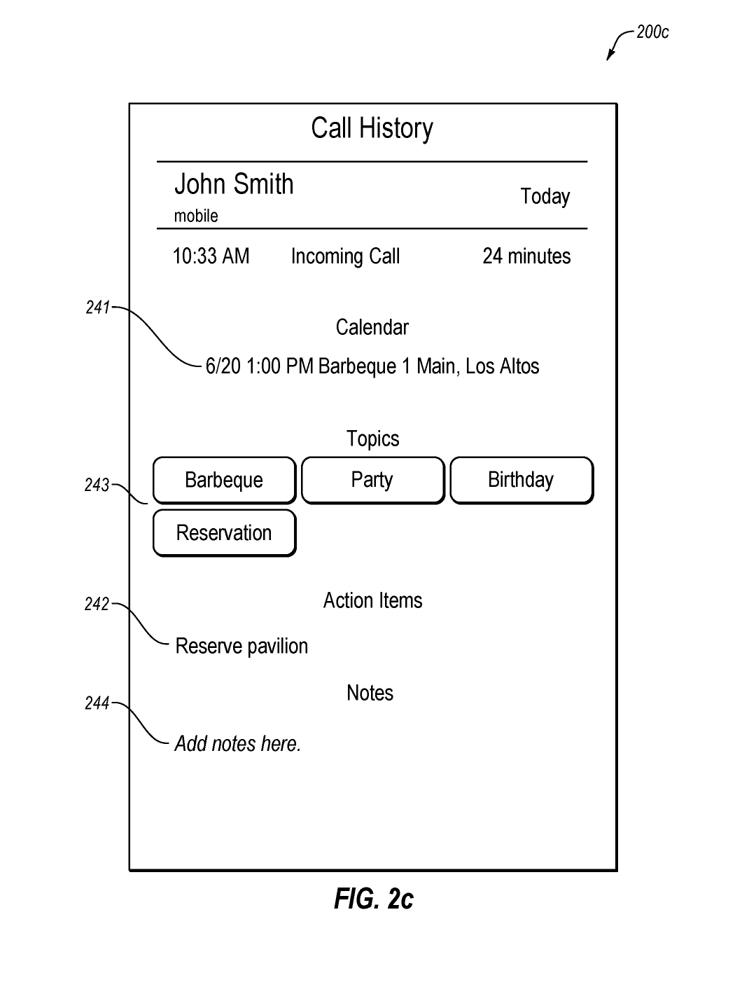

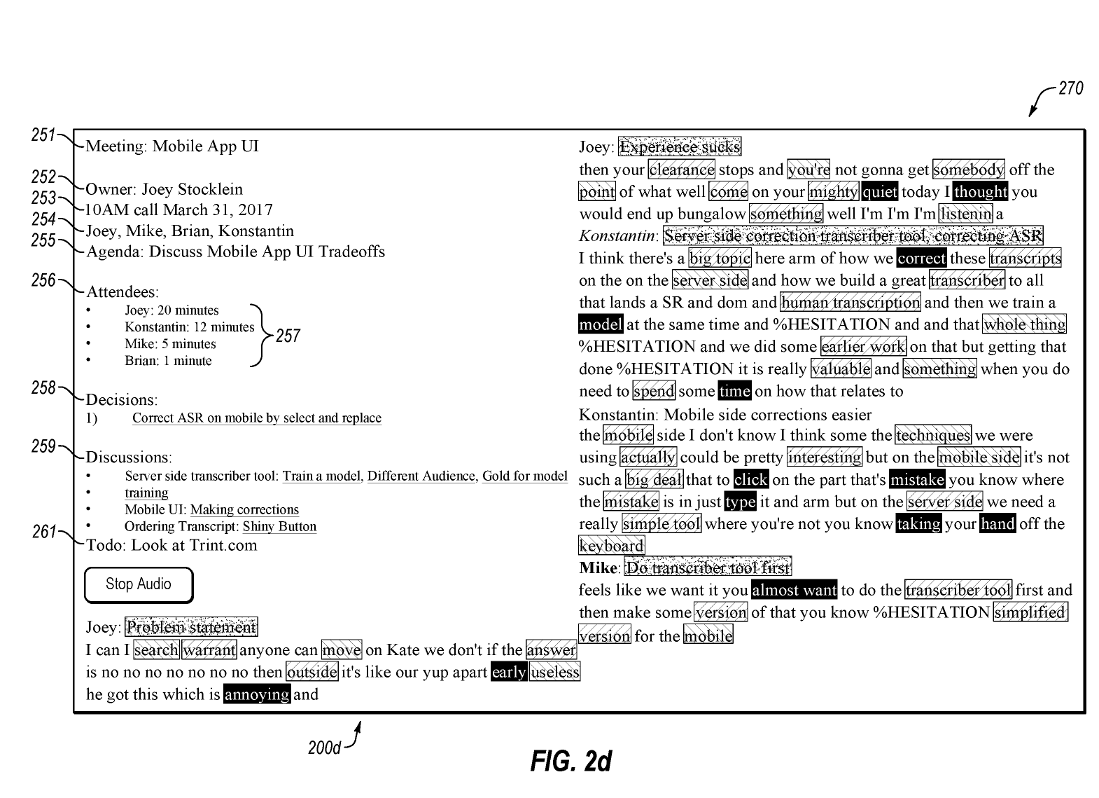

FIGS. 2a-2d illustrate various examples of user interfaces of the user device 120 related to text summaries of calls. FIG. 2a illustrates an example embodiment of a user interface 200a with a call history on the user device 120. The call history may depict multiple calls 210a associated with the user device 120. The calls listed may include inbound calls and outbound calls. Additionally, the call history may include calls that were “missed.” The call history may include details for each of the calls, including a name, a telephone number, a type of call (mobile, VoIP, video VoIP, etc.), a location for calls based on area codes, a date of call, etc. In some embodiments, each of the calls listed may include an “Info” button 220 that may be configured to present more information related to the call on a display of the user device 120. In some embodiments, the “Info” button 220 may include additional text such as “(Rec)” to indicate that the call includes an audio summary and/or a call recording. In some embodiments, the call history may include a “Search” option, which may allow a user of the user device 120 to search the call history based on text summaries of the calls in the call history.

FIG. 2b illustrates an example embodiment of a user interface 220b after a search of the call history on the user device 120 is performed. In some embodiments, the results of a search of the call history may be presented as multiple calls 210b on a display of the user device 120 in response to a user selecting the search option of FIG. 2a and entering the word “barbeque” 230. Alternatively or additionally, in some embodiments, the results of a search of the call history may be presented on the display of the user device 120 in response to a user selecting the search option of FIG. 2a and speaking the word “barbeque” 230 or by speaking the word “search” followed by the word “barbeque.” In these and other embodiments, the call history may be updated to list calls that include the word “barbeque.” In some embodiments, the search may be performed based on the text of the calls in the call history, based on the topics for the calls in the call history, based on notes added to the calls in the call history, or based on other elements of the call history. For example, in some embodiments, the user may search for calls in the call history based on a calendar event, based on a party in the call, based on a name mentioned in the call, based on an address mentioned in the call, or based on other elements of the call. In the example embodiment depicted in FIG. 2b, the calls listed may be calls that include “barbeque” as a topic.

FIG. 2c illustrates an example embodiment of a user interface 200c depicting the information related to a call of the multiple calls 210a in the call history. In some embodiments, the information related to the call may be presented on the display in response to a user selecting the “Info” button of FIG. 2a or 2b for the entry for “John Smith” from “Today.” Alternatively or additionally, in some embodiments, the information related to the call may be presented on the display of the user device 120 in response to a user speaking the word “information” followed by the words “John Smith.” In these and other embodiments, information related to the call may be presented on the display of the user device 120. As discussed above, the text summary of the call may include information related to times, dates, events, and locations for the call. For example, a calendar event 241 may have been created based on the text of the call. In this example, the text of the call may have included an event entitled “Barbeque” scheduled for 1:00 PM on June 20th at 1 Main, Los Altos. The text summary may also include an action item 242 for the user of the user device 120 to reserve a pavilion. The text summary for the call with John Smith today may also include four topics 243, “barbeque,” “party,” “birthday,” and “reservation.” The call information may also include an option for the user to enter notes 244 into the call history for this call.

FIG. 2d illustrates an example embodiment of a user interface 200d depicting the information related to a meeting. In some embodiments, the information may be accessible via a webpage on the Internet. In some embodiments, the information related to the meeting may include a meeting name 251, a meeting owner 252, a meeting time and place 253, participants in the meeting 254, and a meeting agenda 255. The meeting summary may include an automatically generated representation of the meeting, including the attendees 256 and information about the attendees such as the length of time they spoke during the meeting 257; decisions made during the meeting 258, which may be linked to the audio of the meeting and/or the transcription of the meeting; discussions that occurred during the meeting 259, which may be linked (such as hyperlinked) to the audio of the meeting and/or the transcription of the meeting; and a To-Do list 261. The phrase “linked” may include functionality or programming by which a user may “click” or “select” words and may hear the underlying audio associated with the “clicked” or “selected” words or may be presented with a transcription of the words related to the clicked or selected words. Such text and/or audio may be presented in a new window or web browser, or on a pop up, etc. The meeting summary may be configured to process metadata and may place bookmarks in the meeting summary (for example, in response to a command to “Tag that”) or may send notes from the meeting in response to a request to send notes.

The meeting summary may additionally include a transcript of the meeting 270. The transcript may include an identification of the speaker of particular words. In some embodiments, the words of the transcript may be “clickable” or “selectable.” In response to being clicked or selected, a user may listen to the underlying audio associated with the clicked or selected word. Additionally or alternatively, various terms or phrases of the transcript may include one or more different markings (as designated by the different hashmarks associated with the text in FIG. 2d). In these and other embodiments, the different markings may connote any of a variety of designations. For example, the markings may indicate that the phrase is responsible for indicating that the section of the transcript relates to a certain topic. As another example, the markings may indicate one of the keywords identifying a topic. As an additional example, the markings may indicate a word or phrase that the speech recognition engine was unsure of the words. Any other grouping, designation, etc. of the language may be indicated by the markings. In some embodiments, textual characters may also or alternatively be used to designate such groupings or characteristics. For example a special character (e.g., %, &, #, etc.) may indicate that a term is part of a grouping or designation. Additionally or alternatively, such markings may designate textual representations of artifacts of speech not captured in words, such as a pause or hesitation, a cough, yelling, etc.

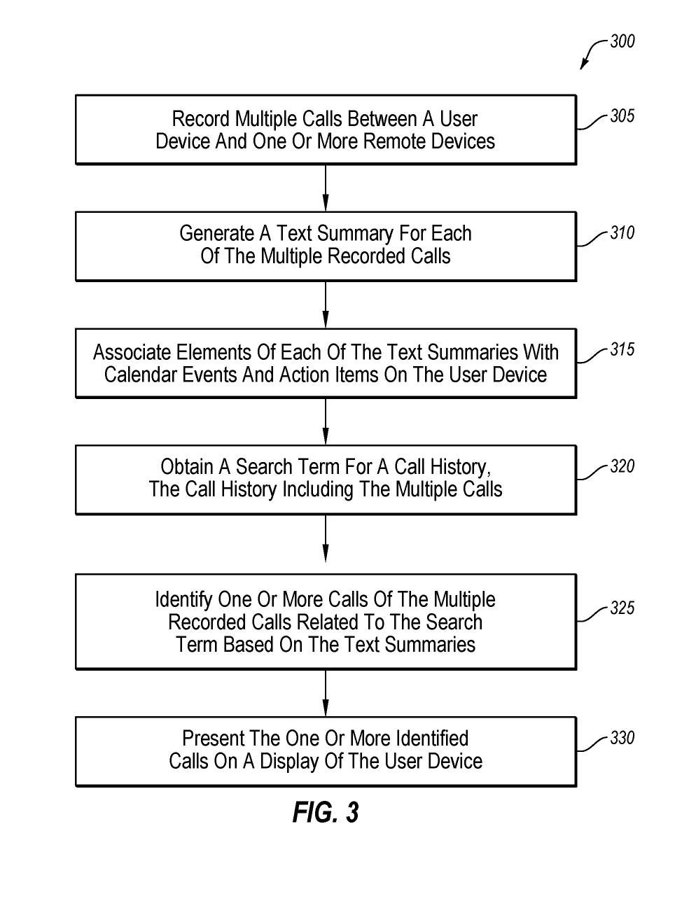

FIG. 3 is a flowchart of an example process 300 of generating an audio summary. One or more steps of the process 300 may be implemented, in some embodiments, by one or more components of environment 100 of FIG. 1, such as the user device 120. Although illustrated as discrete blocks, various blocks may be divided into additional blocks, combined into fewer blocks, or eliminated, depending on the desired implementation.

Process 300 may begin at block 305. At block 305, the user device 120 may record multiple calls between the user device and one or more remote devices.

At block 310, the user device 120 may generate a text summary for each of the multiple recorded calls. The user device 120 may generate a different text summary for each of the multiple recorded calls. In some embodiments, the text summary may be similar to the text summaries described above with respect to FIG. 1 and FIGS. 2a-2d. In these and other embodiments, the text summary may include a transcription of the call, topics discussed during the call, events associated with the call, the number and/or identity of participants to the call, or other elements of the call.

At block 315, the user device 120 may associate elements of each of the text summaries with calendar events and/or action items on the user device 120. For example, the user device 120 may generate a calendar event based on the text summary, which may include an event reminder. In some embodiments, the user device 120 may generate action items based on the text summary of the recorded calls. In some embodiments, this may be undertaken automatically without input from the user of the user device requesting the creation of the calendar event and/or an action item for a to-do list.

At block 320, the user device 120 may obtain a search term to be applied to a call history. The call history may include the multiple calls. In some embodiments, the call history may include recorded calls and calls that are not recorded. In some embodiments, the user device 120 may obtain the search term by textual input by a user of the user device 120. Alternatively or additionally, in some embodiments, the user device 120 may obtain the search term by verbal input by the user.

At block 325, the user device 120 may identify one or more calls of the multiple recorded calls related to the search term based on the text summaries. For example, the identified calls may include the search term in the text summary, in the notes, in related tasks (e.g., calendar events or action items in a to-do list), etc.

At block 330, the user device 120 may present the one or more identified calls on a display of the user device 120.

One skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, in some embodiments, the method 300 may not include the blocks 305, 310, and 315. Alternatively, in some embodiments the method 300 may not include the blocks 320, 325, and 330. In some embodiments, the method 300 may further include selecting a call of the multiple recorded calls and presenting a text summary for the selected call on the display of the user device.

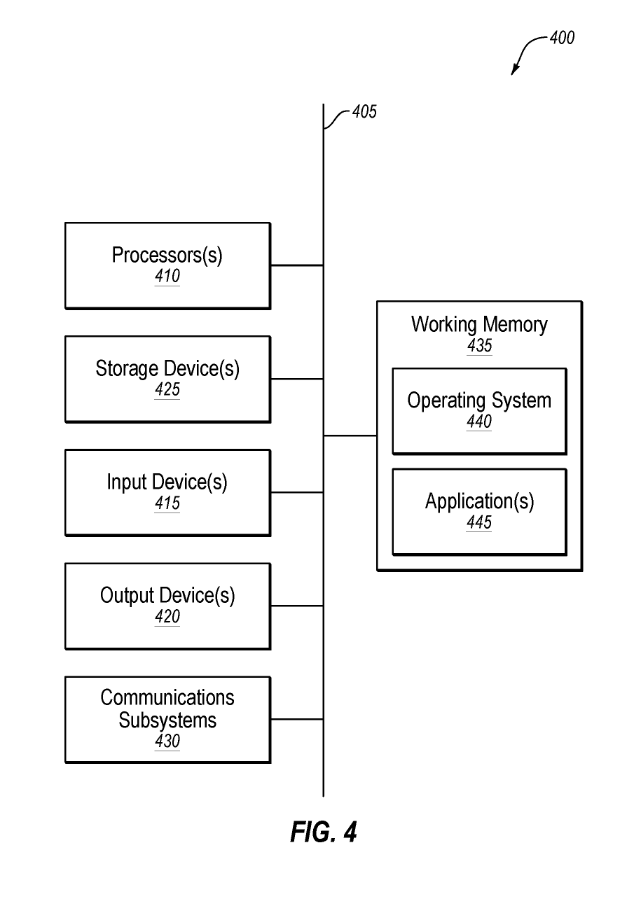

FIG. 4 illustrates an example computational system 400 that may perform one or more of the tasks associated with the present disclosure. The computational system 400 (or processing unit) illustrated in FIG. 4 can be used to perform and/or control operation of any of the embodiments described herein, such as those performed in the environment 100 of FIG. 1. For example, the computational system 400 can be used alone or in conjunction with other components. As another example, the computational system 400 can be used to perform any calculation, solve any equation, perform any identification, and/or make any determination described here.

The computational system 400 may include any or all of the hardware elements shown in FIG. 4 and described herein. The computational system 400 may include hardware elements that can be electrically coupled via a bus 405 (or may otherwise be in communication, as appropriate). The hardware elements can include one or more processors 410, including, without limitation, one or more general-purpose processors and/or one or more special-purpose processors (such as digital signal processing chips, graphics acceleration chips, and/or the like); one or more input devices 415, which can include, without limitation, a mouse, a keyboard, a touchscreen, and/or the like; and one or more output devices 420, which can include, without limitation, a display device, a printer, and/or the like.

The computational system 400 may further include (and/or be in communication with) one or more storage devices 425, which can include, without limitation, local and/or network-accessible storage and/or can include, without limitation, a disk drive, a drive array, an optical storage device, a solid-state storage device, such as random access memory (“RAM”) and/or read-only memory (“ROM”), which can be programmable, flash-updateable, and/or the like. The computational system 400 might also include a communications subsystem 430, which can include, without limitation, a modem, a network card (wireless or wired), an infrared communication device, a wireless communication device, and/or chipset (such as a Bluetooth® device, a 802.6 device, a Wi-Fi device, a WiMAX device, cellular communication facilities, etc.), and/or the like. The communications subsystem 430 may permit data to be exchanged with a network (such as the network described below, to name one example) and/or any other devices described herein. In many embodiments, the computational system 400 will further include a working memory 435, which can include a RAM or ROM device, as described above.

The computational system 400 also can include software elements, shown as being currently located within the working memory 435, including an operating system 430 and/or other code, such as one or more application programs 445, which may include computer programs of the present disclosure, and/or may be designed to implement methods of the present disclosure and/or configure systems of the present disclosure, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 425 described above.

In some cases, the storage medium might be incorporated within the computational system 400 or in communication with the computational system 400. In other embodiments, the storage medium might be separate from the computational system 400 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 400 and/or might take the form of source and/or installable code, which, upon compilation and/or installation on the computational system 400 (e.g., using any of a variety of generally available compilers, installation programs, compression/decompression utilities, etc.), then takes the form of executable code.

Various embodiments are disclosed. The various embodiments may be partially or completely combined to produce other embodiments.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for-purposes of example rather than limitation, and does not preclude inclusion of such modifications, variations, and/or additions to the present subject matter as would be readily apparent to one of ordinary skill in the art.

That which is claimed:

1. A method of generating an audio summary, the method comprising:
recording a plurality of calls between a user device and one or more remote devices;
generating a textual representation of a conversation for each of the plurality of recorded calls; and
providing a call history user interface on the user device from which each textual representation may be accessed.

2. The method of claim 1, wherein the textual representation includes a summary of main points discussed during the call.

3. The method of claim 1, wherein the textual representation includes a list of keywords relevant to the call.

4. The method of claim 1, wherein the textual representation includes a full transcript of the call.

5. The method of claim 1, further comprising providing an indication in the call history user interface whether or not a given call has been recorded.

6. The method of claim 5, wherein the indication further indicates whether audio of the given call is available to for playback, whether the textual representation of the given call is available, or whether both the audio and the textual representation of the given call is available.

7. The method of claim 1, wherein at least part of the textual representation for a given call is visible in the call history user interface in association with the given call.

8. The method of claim 1, wherein the textual representations, audio recordings, or both, are accessible from a web browser.

9. The method of claim 1, further comprising:
obtaining a search term;
identifying one or more calls of the plurality of recorded calls related to the search term based on the textual representations; and
presenting the one or more identified calls on a display of the user device.

10. The method of claim 9, wherein the search is initiated directly from the call history user interface on the user device.

11. The method of claim 9, wherein the search is initiated from a web browser.

12. The method of claim 9, wherein at least one of the textual representations or audio recordings are accessible from the presentation of the one or more identified calls.

13. The method of claim 12, wherein one or more sections of the textual representations, the audio recording, or both, are highlighted to indicate relevance to the search terms.

14. The method of claim 9, wherein the search term is provided by speaking into a microphone of the user device.

15. The method of claim 14, wherein the one or more calls are identified based on a user providing the search term also being a call participant who, during the call, spoke the search term, the identification using phonetic searching.

16. The method of claim 1, further comprising:
analyzing the textual representation to identify words and phrases which indicate an assignment of an action for a call participant; and
taking actions on behalf of the call participant.

17. The method of claim 16, wherein the identified action is at least one of:
schedule a calendar event;
record a task in a task management tool;
insert a bookmark in an audio recording of a given call, the textual representation, or both; or
mark a section of the conversation as private.

18. The method of claim 1, further comprising receiving input from a user of the user device indicating which of the plurality of calls are automatically recorded.

19. The method of claim 18, wherein the input from the user selects at least one of:
a white list of people indicating a list of people, phone numbers, or other endpoint addresses for which all calls are to be recorded; or
a black list of people, phone numbers, or other endpoint addresses for which no calls are to be recorded.

20. A system comprising:
a device for facilitating calls with one or more remote devices;
one or more processors controlling operation of the device for facilitating the calls;
one or more non-transitory computer-readable media containing instructions that, when executed by the one or more processors, causes the system to perform operations, the operations comprising:
record a plurality of calls between the system and the one or more remote devices to be stored in the one or more non-transitory computer-readable media;
generate a textual representation of a conversation for each of the plurality of recorded calls; and
provide a call history user interface from which each textual representation may be accessed.
